(19) United States
(12) Patent Application Publication
(10) Pub. No.: US 2022/0179596 A1
(43) Pub. Date: Jun. 9, 2022

(54) INFORMATION PROCESSING APPARATUS AND NON-TRANSITORY COMPUTER READABLE MEDIUM STORING PROGRAM

(71) Applicant: FUJIFILM Business Innovation Corp., Tokyo (JP)

(72) Inventors: Mamiko SATO, Kanagawa (JP); Junichi SHIMIZU, Kanagawa (JP); Kosuke TOMOKUNI, Kanagawa (JP); Shusaku KUBO, Kanagawa (JP)

(73) Assignee: FUJIFILM Business Innovation Corp., Tokyo (JP)

(21) Appl. No.: 17/327,794

(22) Filed: May 24, 2021

(30) Foreign Application Priority Data
Dec. 3, 2020 (JP) 2020-200866

(51) Int. Cl. G06F 3/12

(52) U.S. Cl. CPC G06F 3/1206; G06F 3/1255; G06F 3/1288; G06F 3/1275; G06F 3/1261

(57) ABSTRACT

An information processing apparatus includes a processor configured to specify plural use apparatuses to use an image of an identical document generated by an image generation apparatus, based on input workflow information, acquire requirements of an input image of each of the plural use apparatuses, and execute a provision process of providing generation information indicating that an image is generated according to a set of values of image attributes satisfying the acquired requirements, to the image generation apparatus.

### CROSS-REFERENCE TO RELATED APPLICATIONS

This application is based on and claims priority under 35 USC 119 from Japanese Patent Application No. 2020-200866 filed Dec. 3, 2020.

### BACKGROUND

### (i) Technical Field

The present invention relates to an information processing apparatus and a non-transitory computer readable medium storing a program.

### (ii) Related Art

There is a system in which an image generation apparatus creates and stores an image for each of all possible sets of values of individual image attributes such as resolution, color mode, and file format, considering the possibility that images will be used later in various different devices (JP2006-261759A).

### SUMMARY

In the system of generating an image for each of all possible sets of values of image attributes, there is a possibility that images not to be used are generated.

Aspects of non-limiting embodiments of the present disclosure relate to an information processing apparatus and a non-transitory computer readable medium storing a program, which reduce the possibility of generating images not to be used, as compared to the system of generating an image for each of all possible sets of values of image attributes.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: specify a plurality of use apparatuses to use an image of an identical document generated by an image generation apparatus, based on input workflow information; acquire requirements of an input image of each of the plurality of use apparatuses; and execute a provision process of providing generation information indicating that an image is generated according to a set of values of image attributes satisfying the acquired requirements, to the image generation apparatus.

### BRIEF DESCRIPTION OF THE DRAWINGS

Exemplary embodiment(s) of the present invention will be described in detail based on the following figures, wherein:

FIG. 1 is a diagram illustrating an example of a system provided with a service provision infrastructure apparatus;

FIG. 2 is a diagram illustrating data contents of a database regarding performance of each image generation apparatus such as a multifunction apparatus included in the system;

FIG. 3 is a diagram illustrating contents of a list of requirements for input images, of each use apparatus such as an OCR server included in the system;

FIG. 4 is a diagram illustrating a part of an example of a processing procedure of the service provision infrastructure apparatus;

FIG. 5 is a diagram illustrating another part of the example of the processing procedure of the service provision infrastructure apparatus;

FIG. 6 is a diagram illustrating another part of the example of the processing procedure of the service provision infrastructure apparatus;

FIG. 7 is a diagram illustrating a list of requirements including requirements modified assuming image conversion;

FIG. 8 is a diagram illustrating a list of optimum conditions for each use apparatus;

FIG. 9 is a diagram illustrating a list of conditions after sharing; and

FIG. 10 is a diagram illustrating an example of a hardware configuration of a computer.

### DETAILED DESCRIPTION

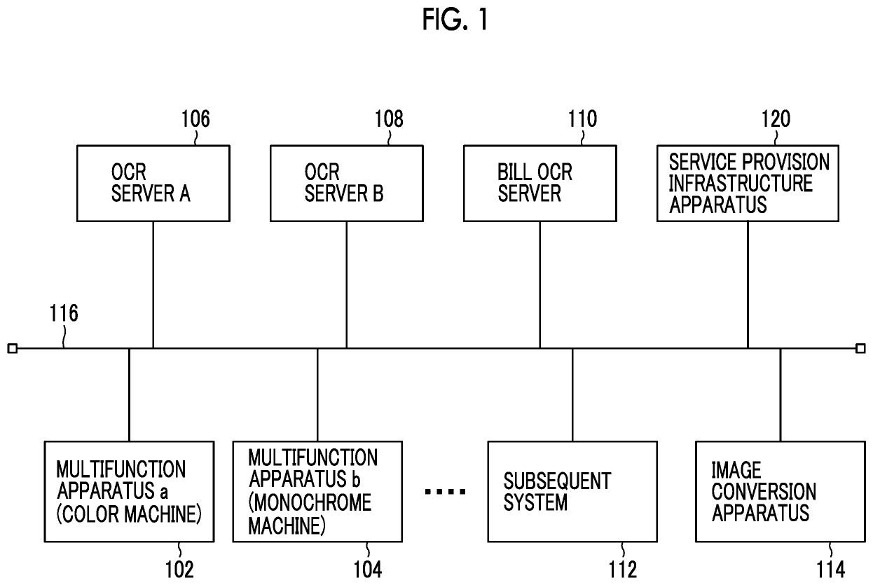

FIG. 1 illustrates a system including a service provision infrastructure apparatus 120. The service provision infrastructure apparatus 120 is an exemplary embodiment of the information processing apparatus according to the present invention.

The system of FIG. 1 includes a multifunction apparatus a 102, a multifunction apparatus b 104, an OCR server A 106, an OCR server B 108, a bill OCR server 110, a subsequent system 112, an image conversion apparatus 114, and a service provision infrastructure apparatus 120, which are connected with each other via a network 116. The network 116 is a network for data communication such as a local area network or the Internet.

The multifunction apparatus a 102 and the multifunction apparatus b 104 are multifunction machines having a scanner, a printer, a copier, a facsimile machine, a network communication function, an information processing function, and the like. In the following, in a case where there is no need to distinguish, the multifunction apparatus a102 and multifunction apparatus b104 are collectively referred to as “multifunction apparatus.”

In this exemplary embodiment, the scanner function is used among the functions of the multifunction apparatus. At least the performance of the scanner function is different between the multifunction apparatus a 102 and the multifunction apparatus b 104. For example, the multifunction apparatus a 102 and the multifunction apparatus b 104 have scan resolutions, color modes, and output data formats different from each other. The color mode is a mode indicating whether the scan is performed in black-and-white or full-color. The system of FIG. 1 may include a multifunction apparatus other than the multifunction apparatus a 102 and the multifunction apparatus b 104 or a scanner.

The OCR server A 106 and the OCR server B 108 are servers that provide an optical character recognition (OCR) function. The OCR server A 106 and the OCR server B 108 have different performances (for example, character types and document types), and the users can use separately according to the performances. The bill OCR server 110 provides a character recognition function specialized for bills such as promissory notes. These three OCR servers have different requirements for input document images (hereinafter, also referred to as “input images”).

Requirements for an input image of a certain apparatus are conditions that the attributes of the input image for that apparatus need to satisfy. Input image attributes include requirements for image attributes such as resolution, color mode, and data format. The system of FIG. 1 may include an OCR server other than the above OCR servers.

The OCR server is an apparatus achieved by executing an optical character recognition program on a computer, and receives a character recognition execution request from a client. Of course, a plurality of OCR servers may be executed on one computer.

The subsequent system 112 receives and processes a document image generated by scanning a document by the multifunction apparatus a 102 or the multifunction apparatus b 104, or the character recognition result data of the OCR server A 106, the OCR server B 108, or a bill OCR server 110 (hereinafter, referred to as “OCR server”, in a case where it is not necessary to distinguish) on the document image. The subsequent system 112 may be, for example, a confirmation correction system that presents a character recognition result and a document image to a human operator and receives confirmation and correction of the character recognition result, or may be a core system for business of a company, or the like. In this example, the subsequent system 112 also defines the requirements for the input document image. The system of FIG. 1 may include two or more subsequent systems 112.

Among the apparatuses in the system of FIG. 1, the multifunction apparatus a 102 and the multifunction apparatus b 104 correspond to an image generation apparatus that generates an image, and each OCR server and the subsequent system 112 correspond to a use apparatus that uses an image.

In the system of FIG. 1, various workflows can be configured in which the information represented by the paper document is digitized and input to the subsequent system 112. For example, an example is a workflow in which an image of an identical one paper document is character-recognized by the OCR server A 106 and the bill OCR server 110, and the two character recognition results are input to the subsequent system 112. Further, there may be a workflow in which an image of a paper document and a character recognition result of the image by the OCR server B 108 are input to the subsequent system 112. The document image is input to the workflow by scanning the paper document with a multifunction apparatus. The document image generated by the multifunction apparatus is provided to apparatuses such as the OCR server and the subsequent system 112 that constitute the workflow.

The image conversion apparatus 114 converts an image into another image. The image conversion function provided by the image conversion apparatus 114 is, for example, a function of converting the resolution of an image. As another example, the conversion function may be to convert a full-color image into a black-and-white grayscale image. In yet another example, the conversion function may be to convert a black-and-white image or a full-color image into a black-and-white binary image. Of course, the conversion function is not limited to the above examples. The image conversion apparatus 114 includes one or more conversion functions among the conversion functions. Further, a plurality of image conversion apparatuses 114 having different conversion functions may be provided on the network 116.

The service provision infrastructure apparatus 120 provides the multifunction apparatus with information necessary for providing each apparatus constituting the workflow with an image that satisfies the requirements of the apparatus.

For this purpose, the service provision infrastructure apparatus 120 has a database of image generation performance of the image generation apparatus in the system of FIG. 1, and a database of requirements for input images of the use apparatus.

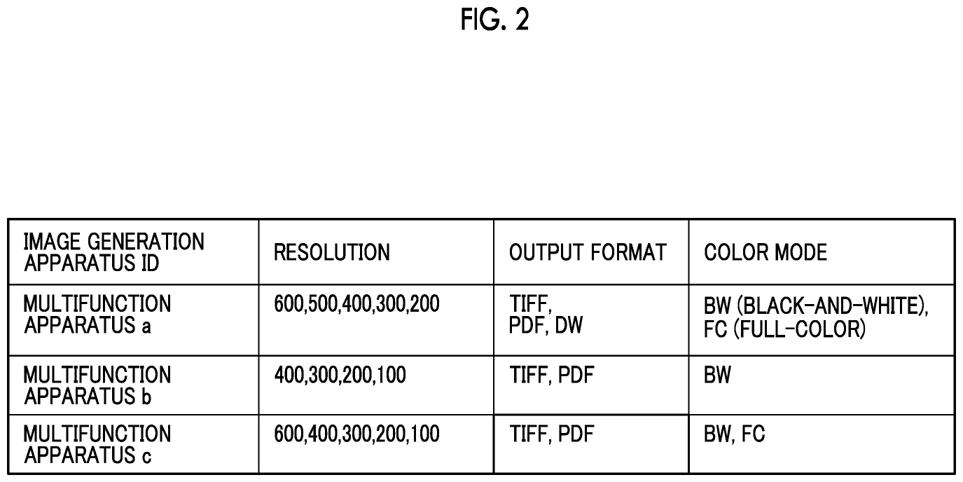

Of these, the data contents of the database for the image generation apparatus are illustrated in FIG. 2. In this database, three attributes (resolution, output format, and color mode) are registered in association with the image generation apparatus ID which is the identification information on the image generation apparatus. The attribute “resolution” is the scan resolution supported by the image generation apparatus. The attribute “output format” is an image data format that the image generation apparatus can output as a scan result. The color mode is a scan color mode supported by the image generation apparatus. For example, an image generation apparatus having an ID of “multifunction apparatus a” (that is, the multifunction apparatus a 102 in FIG. 1) can scan at five different resolutions: 600, 500, 400, 300, and 200 dots per inch (dpi). Further, the multifunction apparatus a 102 can scan in two color modes: black-and-white (BW) and full-color (FC), and can output the document image of the scan result in three types of data formats: TIFF, PDF, and DW. The attributes for the image generation apparatus in the database are not limited to the illustrated resolution, output format, and color mode.

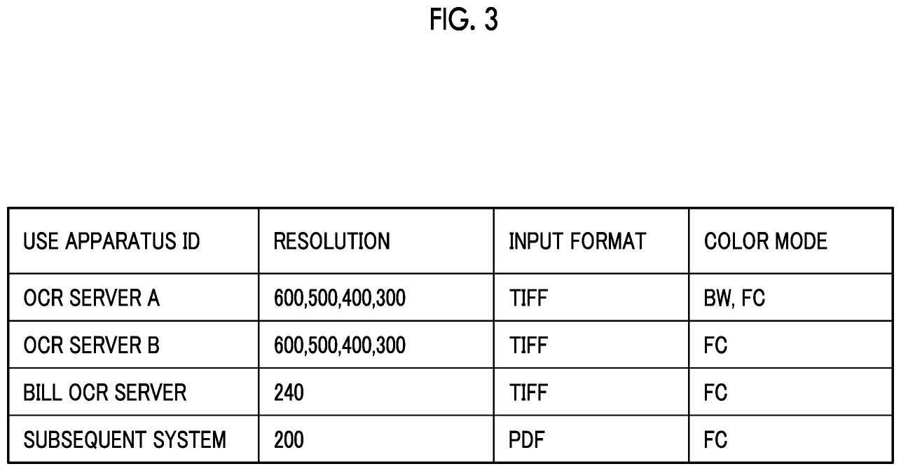

Further, FIG. 3 illustrates a list of requirements for input images of the use apparatus managed by the service provision infrastructure apparatus 120. In this list, three image attributes (resolution, input format, and color mode) are registered in association with the use apparatus ID which is the identification information on the use apparatus. The set of values of these three attributes represents the requirements that the use apparatus imposes on the input image. The attribute “resolution” is the resolution of the image that the use apparatus can accept as an input. The attribute “input format” is a data format of an image that can be accepted by the use apparatus. The color mode is a color mode of an image that can be accepted by the use apparatus. For example, the resolutions of an image that can be accepted by the image generation apparatus having the ID “OCR server A” (that is, the OCR server A 106 in FIG. 1) are limited to four types of 600, 500, 400, and 300 dpi. The color modes of an image that can be accepted by the OCR server A 106 are two types: black-and-white (BW) and full-color (FC), and the data format is limited to TIFF. The attributes of the database of requirements for the input image of the use apparatus are not limited to the illustrated resolution, output format, and color mode.

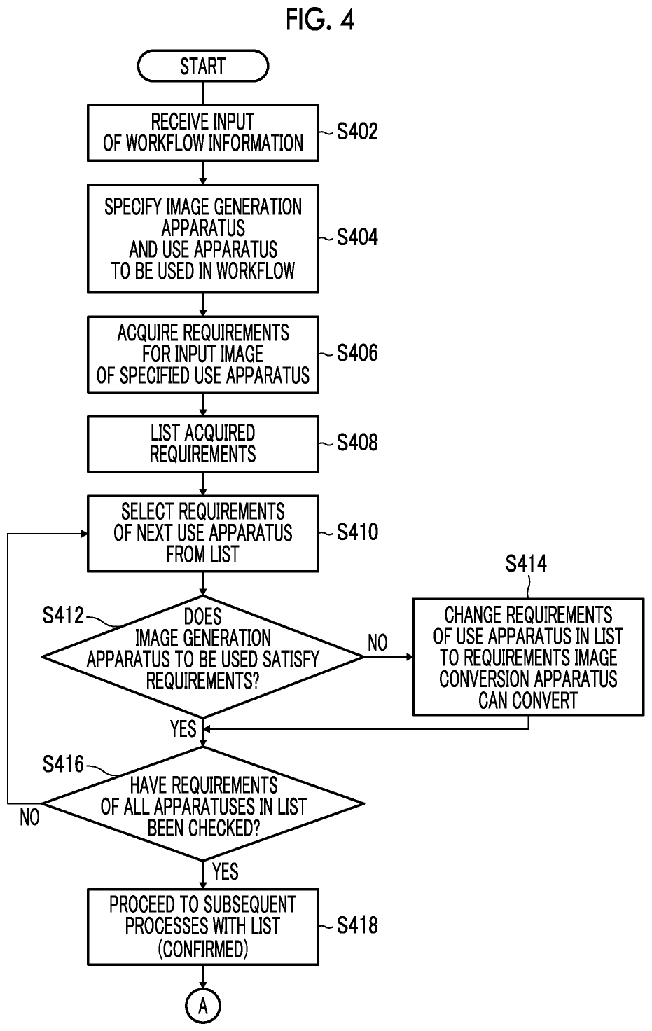

Hereinafter, an example of the processing procedure executed by the service provision infrastructure apparatus 120 will be described with reference to the flowcharts illustrated in FIGS. 4 to 6. In this procedure, a workflow is assumed that the image generation apparatus generates an image of the identical document by scanning or the like, and the image is used by a plurality of use apparatuses. Since the requirements for the input image are different for each use apparatuses, the image generation apparatus generates an image that satisfies each requirement.

As illustrated in FIG. 4, first, the service provision infrastructure apparatus 120 receives input of information (referred to as a workflow definition) for defining the workflow, from a user who intends to execute the workflow in the system of FIG. 1 (S402). The workflow definition includes information that specifies an apparatus that performs the process of each step in the workflow, and this information represents an apparatus that generates data and an apparatus to which the data is passed.

Next, the service provision infrastructure apparatus 120 specifies, from the workflow definition, an image generation apparatus that scans a paper document in the workflow and a use apparatus to which the document image of the scan result of the image generation apparatus is input (S404). Next, the service provision infrastructure apparatus 120 acquires the scan performance of the specified image generation apparatus, and information on the requirements for the input image of the use apparatus from the database (S406), and lists the information on the requirements for the input image of the use apparatus (S408).

Next, the service provision infrastructure apparatus 120 takes out the requirements of one use apparatus in order from the top of the list generated in step S408 (S410), and determines whether the image generation apparatus specified in step S404 has a performance of outputting a document image satisfying the requirements (S412). In this determination, for example, it is determined whether or not the image generation apparatus can satisfy the requirements, for each attribute such as resolution, data format (that is, input format or output format), and color mode. Then, in a case where it is determined that the image generation apparatus can satisfy the requirements for all the attributes, it is determined that the image generation apparatus has the performance to output a document image satisfying the requirements.

In a case where the result of the determination in step S412 is No, the service provision infrastructure apparatus 120 changes requirements for the input image of the use apparatus in the above-described list to requirements that the image generation apparatus can generate and the image conversion apparatus 114 can convert (S414).

In step S414, the input requirements to be satisfied by the input image of the image conversion apparatus 114 (this information is possessed by the service provision infrastructure apparatus 120) are checked, and the requirements for the input image of the use apparatus are converted to the requirements that satisfy at least the input requirements. In a case where the image satisfying the input requirements and the requirements for the input image of a target use apparatus are input, the image conversion apparatus 114 converts the image into an image satisfying the requirements for the input image.

However, in a case where there is a limit in the number of conversions that the image conversion apparatus 114 can perform, the conversion for this situation is selected from the limited number of conversions. The conversion of the image conversion apparatus 114 is defined by a combination of a set of attributes of the conversion source image and a set of attributes of the conversion destination image that can be converted from the conversion source image. In step S414, among these combinations, a combination is specified in which a set of attributes of the image of the conversion destination satisfies the requirements of the input image of the use apparatus, and a set of attributes of the image of the conversion source corresponds to the set of attributes of the image that can be generated by the image generation apparatus. Then, the requirement for the input image of the use apparatus in the list is changed to a set of attributes of the image that can be generated by the image generation apparatus, in the specified combination.

For example, a situation is considered in which the resolution of the requirement imposed by a certain use apparatus is 240 dpi, while the scan function of the image generation apparatus does not support 240 dpi but supports 300 dpi. In this situation, in a case where the image conversion apparatus 114 supports resolution conversion from 300 dpi to 240 dpi, the image conversion apparatus 114 converts the 300 dpi image generated by the image generation apparatus into a 240 dpi image, so that an image that can be accepted by the use apparatus can be prepared. Therefore, in step S414, the resolution among the requirements of the use apparatus in the list is rewritten from 240 dpi to 300 dpi.

For the process of step S414, the service provision infrastructure apparatus 120 holds information on image conversion that can be performed by the image conversion apparatus 114. For example, information on a pair of input resolution and output resolution supported by the image conversion apparatus 114 is held. The image conversion apparatus 114 has a performance of performing resolution conversion from the input resolution to the output resolution indicated by each pair.

In a case where the requirements of a certain use apparatus are changed in step S414, the service provision infrastructure apparatus 120 also stores the original requirements before the change. The stored information on the original requirements is used in a case where the image conversion apparatus 114 converts the document image generated by the image generation apparatus according to the changed requirements into an image that can be accepted by the use apparatus.

In a case where the workflow definition stipulates that a plurality of image generation apparatuses can be used, in step S412, the service provision infrastructure apparatus 120 determines whether there is an image generation apparatus satisfying the requirements of the use apparatus selected, among the plurality of image generation apparatuses. At this time, in a case where it is determined that there is such an image generation apparatus X, the service provision infrastructure apparatus 120 stores the image generation apparatus X as an apparatus for generating a document image to be provided to the use apparatus. In a case where none of plurality of image generation apparatuses satisfy the requirements of the use apparatus, in step S414, among these image generation apparatuses, an image generation apparatus Y capable of generating an image that can be converted to an image satisfying the requirements of the use apparatus by the image conversion apparatus 114 to an image satisfying the requirements of the use apparatus is specified. Then, the requirements for the input image of the use apparatus in the list are changed to requirements that can be generated by the image generation apparatus Y and can be converted by the image conversion apparatus 114, and the image generation apparatus Y is stored as an apparatus for generating a document image to be provided to the use apparatus.

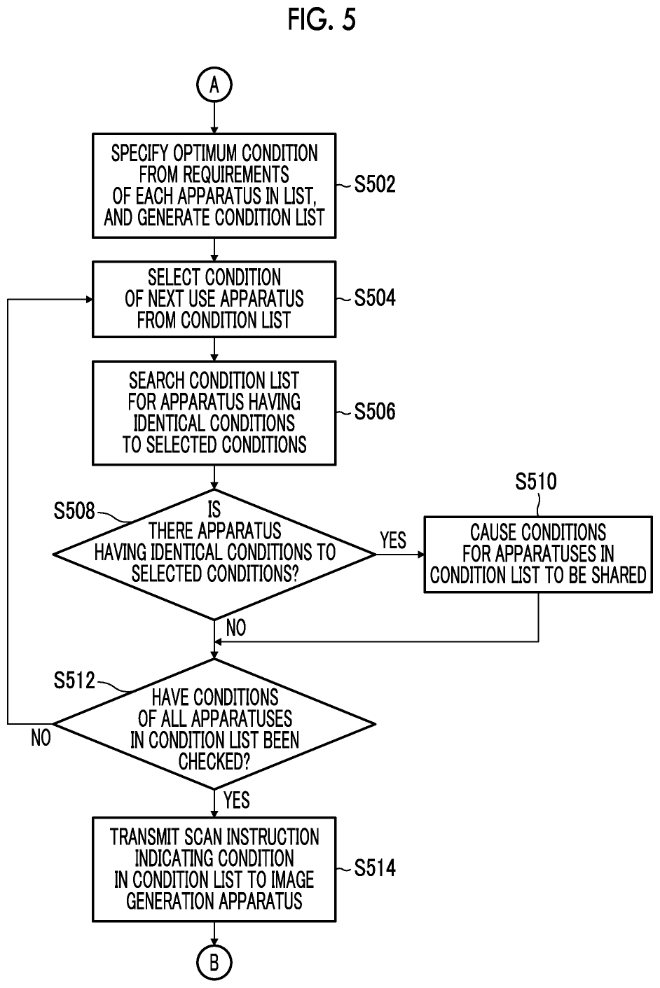

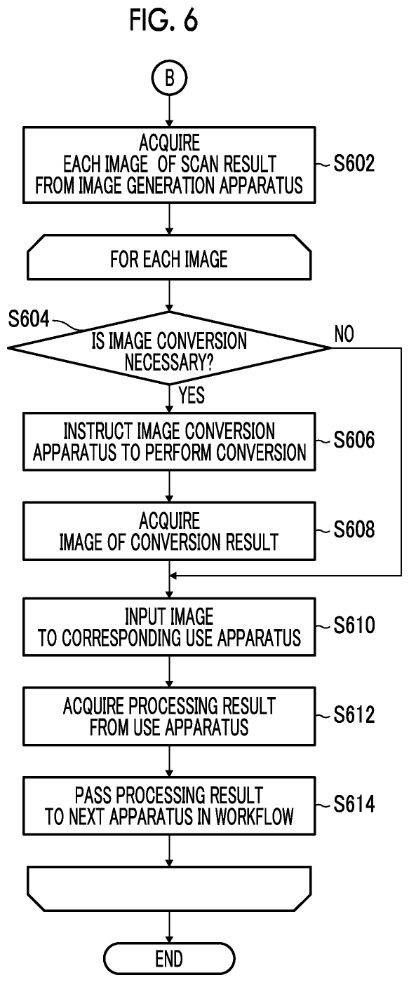

In a case where the determination result in step S412 is Yes, or after step S414, the service provision infrastructure apparatus 120 determines whether the confirmation of step S412 has been completed for the requirements of all the use apparatuses in the list (S416). In a case where the result of this determination is No, the process returns to step S410, the requirement of the next use apparatus is selected from the list, and the determination in step S412 is repeated. In a case where the determination result in step S416 is Yes, the service provision infrastructure apparatus 120 proceeds to the subsequent processes illustrated in FIGS. 5 and 6 with the list. The list at this point has undergone the checking of step S412 (and, in some cases, the change of requirements in step S412) for all the apparatuses in the workflow.

Referring to FIG. 5, next, the service provision infrastructure apparatus 120 specifies the optimum conditions among the requirements of the use apparatus, for each use apparatus in the list, and generates a condition list consisting of the conditions specified for use apparatus (S502). The condition herein is a set (that is, a combination) of values of respective attributes illustrated in the requirement. The optimum condition is a condition in which the quality of the result of the process executed by the use apparatus is the highest, among the plurality of conditions indicated by the requirements of the use apparatus. Regarding OCR, in many cases, the higher the image quality of the input image, especially the resolution, the higher the quality of the character recognition result (in other words, the accuracy of character recognition), so that the condition for obtaining the highest image quality is the optimum condition.

For example, it is assumed that the requirement of the OCR server A 106 in the list is expressed by a combination of each attribute of the OCR server A in the table illustrated in FIG. 3. Since this requirement has four types of resolutions, one type of input format, and two types of color modes, this requirement includes 4×1×2=8 conditions, that is, a set of attribute values. In step S502, among these eight conditions, the optimum condition for the process in the OCR server A 106 is specified. For example, in a case where the higher the resolution of the input image, the higher the accuracy of character recognition, and the accuracy of character recognition is higher in a full-color image than a black-and-white image, the conditions indicated by the combination of (600 dpi, TIFF, full color (FC)) among the eight conditions are specified as the optimum conditions. Then, (600 dpi, TIFF, FC) is registered as the condition of the OCR server A in the condition list. Such process is performed for each use apparatus included in the list of requirements (see FIG. 3).

The service provision infrastructure apparatus 120 selects one use apparatus in order from the first use apparatus in the condition list generated in step S502, and extracts the conditions of the selected use apparatus (S504). Next, the service provision infrastructure apparatus 120 searches the condition list for a use apparatus having the identical conditions to the conditions selected in step S504 (S506). Then, it is determined whether or not the search is successful (S508), and in a case where the search is successful, the conditions for the use apparatuses of the identical conditions in the condition list are collected into a common condition (S510). In the condition list, the common conditions collected in step S510 are recorded in association with the use apparatuses corresponding to the respective conditions before being collected. In a case where the determination result in step S508 is No, step S510 is skipped.

Next, the service provision infrastructure apparatus 120 determines whether or not the checking in step S508 is completed for all use apparatuses in the condition list (S512). In a case where the result of this determination is No, the process returns to step S504, the condition of the next use apparatus is selected from the condition list, and the processes of steps S506 to S512 are repeated.

In a case where the result of the determination in step S512 is Yes, the service provision infrastructure apparatus 120 transmits a scan instruction to the image generation apparatus to execute the scan according to each condition in the condition list (S514). This scan instruction is an example of generation information for generating an image, which is provided to the image generation apparatus, and step S514 is an example of a provision process for providing the generation information to the image generation apparatus. In a case where there are n conditions in the condition list, the scan instruction instructs the execution of the scan according to each of the n conditions.

The image generation apparatus that has received the scan instruction executes a scan according to the condition, for each of then conditions, and generates n document images. The image generation apparatus responds to the service provision infrastructure apparatus 120 by associating the generated n document images with information indicating which of the n conditions corresponds to.

Next, the process proceeds to the procedure illustrated in FIG. 6. In this procedure, in response to the scan instruction in step S514, the service provision infrastructure apparatus 120 acquires a document image of the scan result returned from the image generation apparatus (S602). Then, the processes of steps S604 to S614 are executed for each acquired document image.

The service provision infrastructure apparatus 120 determines whether or not image conversion is necessary for the acquired document image (S604). In a case where the original requirements before the change in step S414 are stored in the conditions associated with the document image, the determination result in step S604 is Yes. In this case, the service provision infrastructure apparatus 120 instructs the image conversion apparatus 114 to convert the document image into an image that satisfies the original requirements (S606). Then, the image of the conversion result is acquired from the image conversion apparatus 114 (S608). In a case where the determination result in step S604 is No, steps S606 and S608 are skipped.

Next, the service provision infrastructure apparatus 120 passes the document image acquired from the image generation apparatus or the image conversion apparatus 114 to the use apparatus recorded in the condition list in association with the conditions associated with the document image (S610). The use apparatus that has received the document image executes the process that the apparatus is in charge of, on the document image, and outputs the data on the processing result. The service provision infrastructure apparatus 120 receives data on the processing result from the use apparatus (S612) and passes the data to the next apparatus of the use apparatus in the workflow (S614).

According to the processing procedure described above, the image generation apparatus generates a document image having the attributes required in the workflow.

In the procedure illustrated above, after the optimum condition is specified for each use apparatus in step S502, common conditions among the optimum conditions for each use apparatus are collected in step S510. However, such a procedure is only an example. As another example, step S502 may be omitted, and all conditions common to the plurality of use apparatuses may be specified in steps S508 and S510. In this case, among the common conditions, the condition for generating an image with the best quality of the processing result of the plurality of use apparatuses is set as the common condition of the plurality of use apparatuses.

The specific flow of the process illustrated in FIGS. 4 to 6 will be described with reference to a workflow example. In this workflow, each of the OCR server A 106, the OCR server B 108, the bill OCR server 110, and the subsequent system 112 acquires the document image of the identical paper document from the multifunction apparatus a 102. Each of the OCR server A 106, the OCR server B 108, and the bill OCR server 110 executes character recognition specific to the server on the acquired document image, and passes data on the character recognition result to the subsequent system 112. The subsequent system 112 executes the process that the subsequent system 112 has, by using the acquired document image and character recognition result of each OCR server. This process may be, for example, a process of registering the document images and each character recognition result in association with each other in the database.

The service provision infrastructure apparatus 120 receives a workflow definition representing such a workflow. Based on the workflow definition, the service provision infrastructure apparatus 120 recognizes that the multifunction apparatus a 102 generates a document image, and the OCR server A 106, the OCR server B 108, the bill OCR server 110, and the subsequent system 112 use the document image. In response to the recognition, the performance information of the multifunction apparatus a 102, and the requirements for the input images of the OCR server A 106, the OCR server B 108, the bill OCR server 110, and the subsequent system 112 are read from the database in the service provision infrastructure apparatus 120. Then, a list of the requirements is generated (step S408 in FIG. 4). It is assumed that the generated list is the list illustrated in FIG. 3.

By executing the loop of steps S410 to S416, the service provision infrastructure apparatus 120 changes the requirements that cannot be satisfied by the performance of the multifunction apparatus a 102 into the requirements that are input considering the use of the image conversion apparatus 114. The requirements subject to such changes can be supported by the multifunction apparatus a 102.

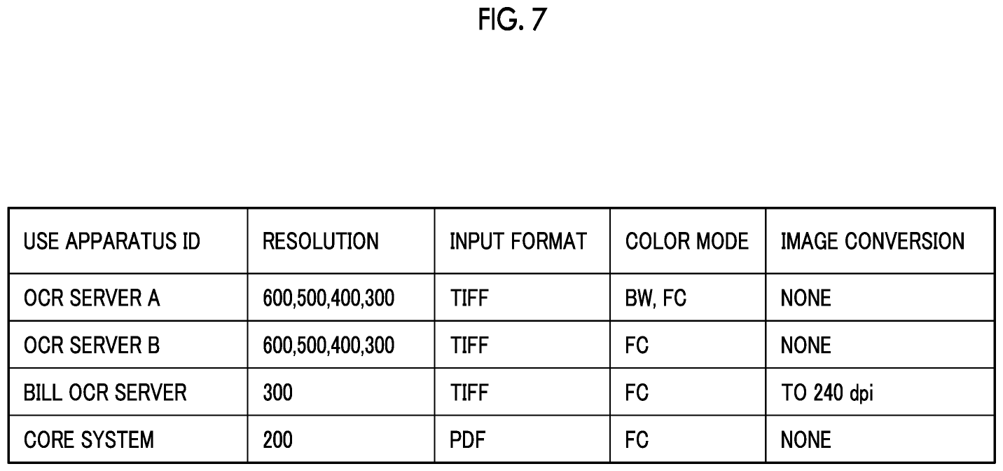

For example, consider a case where the resolution of the input image is 240 dpi in the requirement of the bill OCR server 110, and the multifunction apparatus a 102 does not support scanning at that resolution. In this case, in step S414, the service provision infrastructure apparatus 120 obtains the scan resolution supported by the multi function apparatus a 102, from the performance information of the multifunction apparatus a 102. Further, from the performance information of the image conversion apparatus 114, the resolution of the conversion source that the image conversion apparatus 114 can convert to 240 dpi is obtained. Then, the resolution that matches between the scan resolution and the resolution of the conversion source is specified, and the resolution of the requirement is changed to the specified resolution. For example, in a case where the multifunction apparatus a 102 can scan at 300 dpi and the image conversion apparatus 114 can convert an image of 300 dpi into an image of 240 dpi, the resolution 240 dpi in the requirement is rewritten to 300 dpi. FIG. 7 illustrates a list of the requirements for the bill OCR server 110 after the resolution has been changed from 240 dpi to 300 dpi. For the requirements for using the image conversion in the image conversion apparatus 114, information on the image conversion is registered in this list. In the illustrated example, information to convert (the image of 300 dpi generated by the multifunction apparatus a 102) to 240 dpi is registered in association with the condition of the bill OCR server 110.

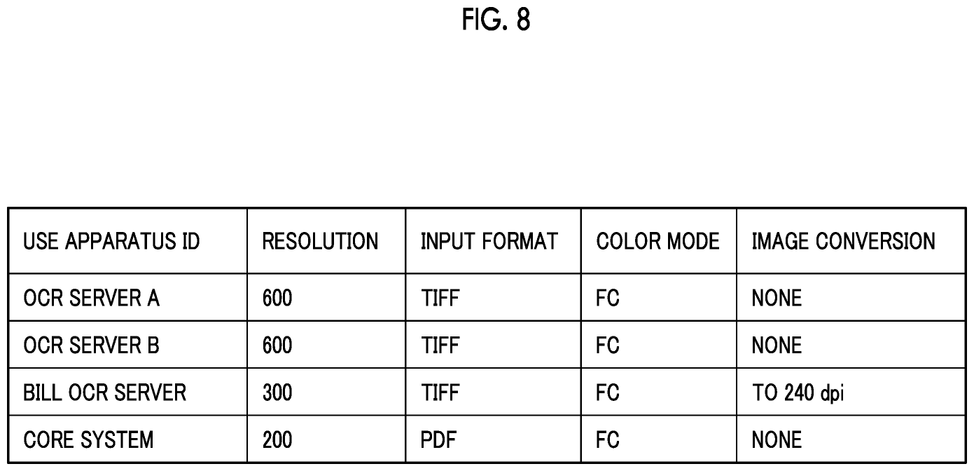

Next, the service provision infrastructure apparatus 120 extracts the optimum conditions from the requirements of each use apparatus included in the list of FIG. 7, and generates a condition list including the optimum conditions (step S502 of FIG. 5). As illustrated in FIG. 8, this condition list has a single condition (that is, a set in which the value of each attribute is one) for each use apparatus. Information on the image conversion is also carried over to the condition list.

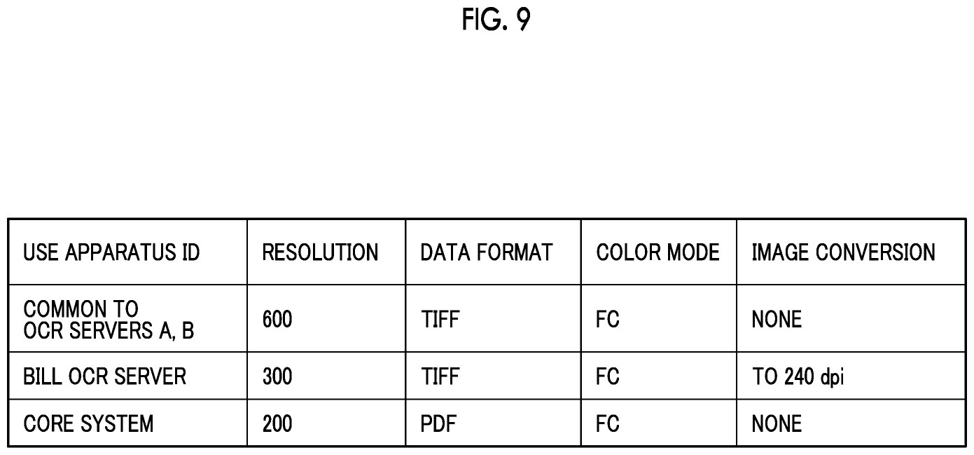

Next, the service provision infrastructure apparatus 120 causes the identical condition in the condition list to be shared, in steps S508 and S510. In a case where this sharing is performed for the example of FIG. 8, the condition list illustrated in FIG. 9 is obtained. In the example of FIG. 9, the conditions of the OCR server A 106 and the OCR server B 108 are collected into one.

The service provision infrastructure apparatus 120 transmits an instruction to the multifunction apparatus a 102 to execute the scan according to the three conditions illustrated in the final condition list illustrated in FIG. 9. For each condition included in the instruction, the multifunction apparatus a 102 scans the set paper document, according to the condition. This generates three document images obtained by scanning under different conditions. The multifunction apparatus a 102 responds to the service provision infrastructure apparatus 120 by associating the three document images with information indicating the corresponding conditions.

In the above example, in step S502, by narrowing down to the optimum condition among the plurality of conditions included in the requirements of the use apparatus, an image corresponding to the optimum condition is provided to each use apparatus. However, in this method, the number of images generated by the image generation apparatus is large due to the workflow.

Therefore, as another method, a method of covering as many use apparatuses as possible with a common image may be adopted without performing such narrowing down. In this method, the service provision infrastructure apparatus 120 obtains, for example, a combination of the minimum conditions that can cover all the use apparatuses in the workflow, instead of the procedure illustrated in FIG. 5. In the case of the list illustrated in FIG. 7, all the use apparatuses can be covered by a total of two conditions: Condition 1 (300 dpi, TIFF, FC) and Condition 2 (200 dpi, PDF, FC). The condition 1 is a common condition that can cover the OCR server A 106, the OCR server B 108, and the bill OCR server 110, and the condition 2 is a condition for the subsequent system 112.

Further, in the above-described exemplary embodiment, there is only one image conversion apparatus 114, but there may be a plurality of image conversion apparatuses 114 in the system. In this case, in step S414, the service provision infrastructure apparatus 120 selects an image conversion apparatus capable of converting an image having an attribute of an image that can be generated by the image generation apparatus into an image having an attribute that satisfies the requirements for the input image of the use apparatus, from the plurality of image conversion apparatuses 114. Then, the requirements for the input image of the use apparatus in the list are changed to requirements that can be generated by the image generation apparatus and can be converted by the selected image conversion apparatus 114.

In the exemplary embodiment described above, the scanner function of one or more multifunction apparatuses or image generation apparatuses scans the identical document to generate a plurality of image data having different attributes. However, this is only an example. The method of the above exemplary embodiment can also be applied to a case where one or more image generation apparatuses perform one or more image processing such as resolution conversion, compression, or file format conversion on the identical original image data, and generates a plurality of images having different attributes.

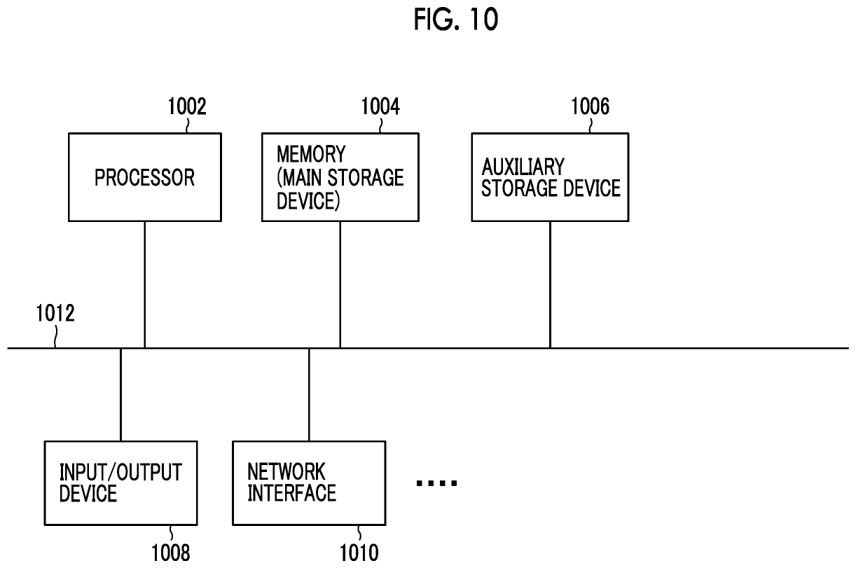

The service provision infrastructure apparatus 120 in the above exemplary embodiment is achieved, for example, by executing a program on computer hardware. As illustrated in FIG. 10, the computer hardware has a circuit configuration in which a processor 1002, a memory (main storage device) 1004 such as a random access memory (RAM), an auxiliary storage device 1006 that is a non-volatile storage device such as a flash memory, a solid state drive (SSD), and a hard disk drive (HDD), an interface with various input/output devices 1008, a network interface 1010 that controls connection to a network such as a local area network, and the like are connected via a data transmission path such as a bus 1012. A program in which the contents of the processes of the above exemplary embodiment are described is installed in the computer via a network or the like, and stored in the auxiliary storage device 1006. The service provision infrastructure apparatus 120 of this exemplary embodiment is achieved by executing the program stored in the auxiliary storage device 1006 by the processor 1002 using the memory 1004.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
specify a plurality of use apparatuses to use an image of an identical document generated by an image generation apparatus, based on input workflow information;
acquire requirements of an input image of each of the plurality of use apparatuses; and
execute a provision process of providing generation information indicating that an image is generated according to a set of values of image attributes satisfying the acquired requirements, to the image generation apparatus.

2. The information processing apparatus according to claim 1,
wherein in a case where there is a set of values of common image attributes that satisfy the requirements of a group of use apparatuses among the specified plurality of use apparatuses, in the provision process, a single piece of generation information indicating that an image is generated according to the set of values of common image attributes for the group of use apparatuses is provided to the image generation apparatus, and
the processor is configured to receive the image generated by the image generation apparatus according to the single piece of generation information, and input the image to each of the group of use apparatuses.

3. The information processing apparatus according to claim 2,
wherein in a case where there are a plurality of the sets of values of common image attributes, the single piece of generation information is generation information indicating that an image is generated according to a set having a highest quality of a processing result of the group of use apparatuses, among the plurality of sets.

4. The information processing apparatus according to claim 2,
wherein in a case where there are a plurality of the sets of values of common image attributes, the single piece of generation information is generation information indicating that an image is generated according to a set having a highest quality of the image, among the plurality of sets.

5. The information processing apparatus according to claim 1,
wherein the number of images generated by the image generation apparatus according to the generation information is smaller than the number of the plurality of use apparatuses.

6. The information processing apparatus according to claim 1,
wherein in the provision process, in a case where the image generation apparatus is not able to generate an image having a set of values of image attributes satisfying first requirements that are the requirements of a first use apparatus among the plurality of use apparatuses, the set is changed to a set of values of image attributes satisfying requirements of an input image of an image conversion apparatus, and generation information indicating that an image is generated according to the changed set, and
the processor is configured to provide to the image conversion apparatus, a conversion instruction to convert the image generated by the image generation apparatus according to the changed generation information into an image having the set satisfying the first requirements, and input the converted image generated by the image conversion apparatus in response to the conversion instruction to the first use apparatus.

7. The information processing apparatus according to claim 2,
wherein in the provision process, in a case where the image generation apparatus is not able to generate an image having a set of values of image attributes satisfying first requirements that are the requirements of a first use apparatus among the plurality of use apparatuses, the set is changed to a set of values of image attributes satisfying requirements of an input image of an image conversion apparatus, and generation information indicating that an image is generated according to the changed set, and
the processor is configured to provide to the image conversion apparatus, a conversion instruction to convert the image generated by the image generation apparatus according to the changed generation information into an image having the set satisfying the first requirements, and input the converted image generated by the image conversion apparatus in response to the conversion instruction to the first use apparatus.

8. The information processing apparatus according to claim 3,
wherein in the provision process, in a case where the image generation apparatus is not able to generate an image having a set of values of image attributes satisfying first requirements that are the requirements of a first use apparatus among the plurality of use apparatuses, the set is changed to a set of values of image attributes satisfying requirements of an input image of an image conversion apparatus, and generation information indicating that an image is generated according to the changed set, and
the processor is configured to provide to the image conversion apparatus, a conversion instruction to convert the image generated by the image generation apparatus according to the changed generation information into an image having the set satisfying the first requirements, and input the converted image generated by the image conversion apparatus in response to the conversion instruction to the first use apparatus.

9. The information processing apparatus according to claim 4,
wherein in the provision process, in a case where the image generation apparatus is not able to generate an image having a set of values of image attributes satisfying first requirements that are the requirements of a first use apparatus among the plurality of use apparatuses, the set is changed to a set of values of image attributes satisfying requirements of an input image of an image conversion apparatus, and generation information indicating that an image is generated according to the changed set, and
the processor is configured to provide to the image conversion apparatus, a conversion instruction to convert the image generated by the image generation apparatus according to the changed generation information into an image having the set satisfying the first requirements, and input the converted image generated by the image conversion apparatus in response to the conversion instruction to the first use apparatus.

10. The information processing apparatus according to claim 5,
wherein in the provision process, in a case where the image generation apparatus is not able to generate an image having a set of values of image attributes satisfying first requirements that are the requirements of a first use apparatus among the plurality of use apparatuses, the set is changed to a set of values of image attributes satisfying requirements of an input image of an image conversion apparatus, and generation information indicating that an image is generated according to the changed set, and
the processor is configured to provide to the image conversion apparatus, a conversion instruction to convert the image generated by the image generation apparatus according to the changed generation information into an image having the set satisfying the first requirements, and input the converted image generated by the image conversion apparatus in response to the conversion instruction to the first use apparatus.

11. The information processing apparatus according to claim 6, wherein in the provision process, in a case where there are a plurality of the image conversion apparatuses, an image conversion apparatus that is able to generate the image having a set of values of image attributes satisfying the first requirements, as a conversion result, is specified from among the plurality of image conversion apparatuses, and the set for the first use apparatus is changed to a set of values of image attributes satisfying the requirements of the input image of the specified image conversion apparatus.

12. The information processing apparatus according to claim 7, wherein in the provision process, in a case where there are a plurality of the image conversion apparatuses, an image conversion apparatus that is able to generate the image having a set of values of image attributes satisfying the first requirements, as a conversion result, is specified from among the plurality of image conversion apparatuses, and the set for the first use apparatus is changed to a set of values of image attributes satisfying the requirements of the input image of the specified image conversion apparatus.

13. The information processing apparatus according to claim 8, wherein in the provision process, in a case where there are a plurality of the image conversion apparatuses, an image conversion apparatus that is able to generate the image having a set of values of image attributes satisfying the first requirements, as a conversion result, is specified from among the plurality of image conversion apparatuses, and the set for the first use apparatus is changed to a set of values of image attributes satisfying the requirements of the input image of the specified image conversion apparatus.

14. The information processing apparatus according to claim 9, wherein in the provision process, in a case where there are a plurality of the image conversion apparatuses, an image conversion apparatus that is able to generate the image having a set of values of image attributes satisfying the first requirements, as a conversion result, is specified from among the plurality of image conversion apparatuses, and the set for the first use apparatus is changed to a set of values of image attributes satisfying the requirements of the input image of the specified image conversion apparatus.

15. The information processing apparatus according to claim 10, wherein in the provision process, in a case where there are a plurality of the image conversion apparatuses, an image conversion apparatus that is able to generate the image having a set of values of image attributes satisfying the first requirements, as a conversion result, is specified from among the plurality of image conversion apparatuses, and the set for the first use apparatus is changed to a set of values of image attributes satisfying the requirements of the input image of the specified image conversion apparatus.

16. A non-transitory computer readable medium storing a program causing a computer to execute a process comprising:
specifying a plurality of use apparatuses to use an image of an identical document generated by an image generation apparatus, based on input workflow information;
acquiring requirements of an input image of each of the plurality of use apparatuses; and
executing a provision process of providing generation information indicating that an image is generated according to a set of values of image attributes satisfying the acquired requirements, to the image generation apparatus.

17. An information processing apparatus comprising:
means for specifying a plurality of use apparatuses to use an image of an identical document generated by an image generation apparatus, based on input workflow information;
means for acquiring requirements of an input image of each of the plurality of use apparatuses; and
means for executing a provision process of providing generation information indicating that an image is generated according to a set of values of image attributes satisfying the acquired requirements, to the image generation apparatus.
